(19) United States
(12) Patent Application Publication
(10) Pub. No.: US 2024/0345424 A1
(43) Pub. Date: Oct. 17, 2024

(54) GLASS PANEL DEVICE AND METHOD FOR CONTROLLING A GLASS PANEL DEVICE

(71) Applicant: Webasto SE, Stockdorf (DE)

(72) Inventors: Rainer Staude, Stockdorf (DE); Rudolf Haeussermann, Stockdorf (DE)

(21) Appl. No.: 18/292,800

(22) PCT Filed: Oct. 10, 2022
(86) PCT No.: PCT/EP2022/078102

§ 371 Date: Jan. 26, 2024

(30) Foreign Application Priority Data
Oct. 13, 2021 (DE) 102021126557.6

(51) Int. Cl. G02F 1/01; B60J 3/04

(52) U.S. Cl. CPC G02F 1/0121; B60J 3/04; G02F 2201/50

(57) ABSTRACT

A glass panel device having a switchable glass panel and a control unit for controlling the switchable glass panel with a control voltage is provided, where the control voltage is composed of a first AC voltage signal and a second AC voltage signal, where the first AC voltage signal is phase-shifted by 180° with respect to the second AC voltage signal; the control unit has a first analogue amplifier for amplifying the first AC voltage signal comprising two first power switches and a second analogue amplifier for amplifying the second AC voltage signal comprising two second power switches, where each one power switch of the two analogue amplifiers together form an upper voltage circuit and the respective other power switches of the two analogue amplifiers together form a lower voltage circuit.

### CROSS-REFERENCE TO RELATED APPLICATIONS

This application is a 35 U.S.C. § 371 National Stage Entry of International Application No. PCT/EP2022/078102 filed Oct. 10, 2022, which claims the priority benefit of German Patent Application Serial Number DE 10 2021 126 557.6 filed Oct. 13, 2021, all of which are incorporated herein by reference in their entirety for all purposes.

### TECHNICAL FIELD

The invention relates to a glass panel device, a method for controlling the glass panel device as well as to a motor vehicle having a glass panel device.

### BACKGROUND

Switchable or smart glass (e.g. LC, PDLC or SPD) are films, which may change its optical properties from transparent to opaque and vice versa when an AC (alternating current) voltage is applied. Such films are used, for example, for glass panes in buildings or motor vehicles—e.g. in the form of a glass roof—where a transparent, i.e., translucent, and an opaque, i.e., lightproof, state is required or desired by a customer.

Depending on the technology, switchable glass is usually controlled with a sinusoidal voltage between 20 V-AC and 180 V-AC. Other AC voltage curves are thus possible. If only the “switched on” (e.g. opaque) and “switched off” (e.g. transparent) states are required, a transformer with a corresponding transformation ratio may thus be used for connection to a 240 V-AC network.

If the AC voltage is generated from a DC (direct current) voltage, which is the case in a motor vehicle for example, an inverter is required. This may be realized using the following circuits, among others:
a bridge circuit (full bridge)
a class D amplifier or
an analogue amplifier

A bridge circuit in the form of a full bridge may be implemented with ease. However, a rectangular voltage curve which it provides has a disadvantage that it generates high-frequency EMC interference in cables and in the foil. To avoid this, a correspondingly large LC filter is required, for example. In addition, the digital switching of the relatively high voltage generates EMC interference on existing PCBs. This may necessitate a metal housing required for shielding.

A class D amplifier is used for example in audio amplifiers. This is a digital half-bridge that is controlled with a pulse-width modulated signal. However, high-frequency EMC interference can also occur here. For this reason, an LC filter and possibly a metal housing are usually required for shielding, which renders the overall design cost-intensive and complex.

Control by means of an analogue amplifier is described, for example, in DE 10 2016 214 292 A1. Control using an analogue amplifier does not generate any high-frequency EMC interference. However, this type of control is associated with a relatively high power loss. Extensive cooling is therefore required here.

### SUMMARY

Based on this, the invention has an object of providing a glass panel device and a method for controlling a glass panel device in which no EMC interference occurs and the power loss is reduced.

With regard to the glass panel device, the object is solved in accordance with the invention by a glass panel device comprising the features of claim 1. With regard to the method, the object is solved in accordance with the invention by a method for controlling a glass panel device comprising the features of claim 7.

Advantageous embodiments, further developments and variants are subject of the dependent claims. The advantages and preferred embodiments stated with regard to the glass panel device are analogously applicable to the method and vice versa.

Specifically, the object underlying the glass panel device is solved by a glass panel device which has a switchable glass panel and a control unit for controlling the switchable glass panel with a control voltage. The control voltage is composed of a first AC voltage signal and a second AC voltage signal, the first AC voltage signal being electrically phase-shifted by 180° relative to the second AC voltage signal.

Furthermore, the control unit has a first analogue amplifier with two first power transistors for amplifying the first AC voltage signal and a second analogue amplifier with two second power transistors for amplifying the second AC voltage signal. The power transistors may, for example, be designed as MOSFETs or alternatively as bipolar transistors. Each one power transistor of the two analogue amplifiers together form an upper voltage circuit. In other words, the upper voltage circuit is formed by one of the two power transistors of the first analogue amplifier and one of the two power transistors of the second analogue amplifier. Similarly, the other power transistors of the two analogue amplifiers jointly form a lower voltage circuit.

The switchable glass panel is further connected between an output of the first analogue amplifier and an output of the second analogue amplifier. As a result, a negative supply voltage can be dispensed with.

By using the analogue amplifiers, the EMC interference mentioned in the introduction can be avoided. As a result, it is possible to use cost-effective plastic housings, since cost-intensive metal housings for shielding can be dispensed with. Furthermore, no further filter components are necessary, which likewise leads to a cost and design advantage.

The control unit further has a first voltage regulator, which is configured to apply a variable supply voltage to the upper voltage circuit. As a result, it is possible to correspondingly lower the supply voltage in the regions between the peaks of the sinusoidal control signal. By means of a supply voltage optimized in this way, the power loss in the upper voltage circuit can be reduced by, for example, approximately 30% in comparison with conventional analogue amplifier circuits. If percentage data relating to a saving/reduction of a power loss are specified below, these always relate to the comparison with a conventional analogue amplifier circuit having a sinusoidal output voltage.

According to an alternative embodiment, the control unit has a discharge unit, which is connected between the output of the first analogue amplifier and the output of the second analogue amplifier. As a result, it is possible to discharge the switchable glass panel with half the control voltage, which reduces the power loss by approximately 50% in comparison with known, conventional analogue amplifier circuits. Bipolar transistors or MOSFETs, for example, can be used to implement the discharge circuit. Switching elements of this type are available on the market in a wide variety of variants and configurations, so that the discharge unit can be implemented firstly with simple means and secondly can be optimally adapted with respect to the power parameters of the glass panel device.

By means of the described configuration, the power loss can be reduced by up to 65% in comparison with known analogue amplifier circuits. The minimization of the power loss by the configuration described above is explained again in the context of the description of the figures using a specific example. Specifically, when using MOSFETs for the analogue amplifier and when skillfully generating the signal forms of the AC voltage signals, the additional components for a discharge circuit can be dispensed with, which again advantageously influences the structure of the glass panel device.

In one development, the control unit further has a second voltage regulator, which is configured to apply a variable supply voltage to the lower voltage circuit. Similarly to the application of a variable supply voltage to the upper voltage circuit, the lower voltage circuit is also supplied with a variable voltage supply. As a result, a further power loss reduction by approximately 15% can be implemented.

In one embodiment, the second voltage regulator has a switch, a diode and a comparator. Since, in particular in the case of motor vehicles, the voltage provided is usually approximately 12-13 V, the second voltage regulator can be easily implemented by means of the above-mentioned components, so that as a result the “lower supply voltage”, i.e. the supply voltage of the lower voltage circuit, is switched back and forth between ground and vehicle voltage. The control is effected by means of the comparator. In addition, current flows back into the vehicle battery during operation, while the power transistor of the second voltage regulator is open. As a result, the total power can additionally be reduced.

By means of the configuration described above, approximately 7% power loss can be saved on its own (based on the power loss without any optimization) with little outlay. The maximum saving is approximately 70% (based on the power loss without any optimization).

By means of the further reduced power loss, it is ensured with this embodiment that the control of the switchable glass panel functions without errors even at temperatures with a value of up to 105° C. This “temperature resistance” is relevant in particular when using the switchable glass panel as a vehicle roof in a motor vehicle, since such temperature values can occur in motor vehicle components in particular in the summer. In one embodiment, the power transistors of the first analogue amplifier and the power transistors of the second analogue amplifier are formed as bipolar transistors or MOSFETs. The advantage of this configuration is that components of this type are available in various variants and the analogue amplifiers can thus be easily and optimally adapted or constructed to the respective requirements.

In one embodiment, the first AC voltage signal and the second AC voltage signal each have a voltage value in the range of 40V to 80V. This results in a peak-to-peak value of the control signal of correspondingly 80V to 160V. Such voltage values have proven advantageous and sufficient to control known switchable glass panels. The first and the second AC voltage signal may be generated by an inverter since the present (on-board) voltage in a motor vehicle is usually DC voltage.

Specifically, the object directed to the method is solved by a method for controlling a switchable glass panel which is connected between an output of a first analogue amplifier and an output of a second analogue amplifier, wherein each one power transistor of the two analogue amplifiers together form an upper voltage circuit and each respective other power transistor of the two analogue amplifiers together form a lower voltage circuit, the method comprising the following steps:
applying to the switchable glass panel a control voltage which is provided by the two analogue amplifiers, wherein the control voltage is composed of a first AC voltage signal and a second AC voltage signal phase-shifted by 180° with respect to the first AC voltage signal, and
discharging the switchable glass panel, wherein the output of the first analogue amplifier is discharged via the output of the second analogue amplifier.

In one embodiment, the method further comprises the step of:
discharging the switchable glass panel, wherein the output of the first analogue amplifier is additionally discharged via a ground potential.

In other words, the discharge of the switchable glass panel thus takes place primarily via the output of the second analogue amplifier and (additionally) via a ground potential.

In particular by means of the above-described method steps of discharging the switchable glass panel in the at least one discharge phase, an additional discharge circuit and the control thereof can be dispensed with, since the discharge advantageously takes place via the existing components. Since a microcontroller is usually used anyway in a control unit for switchable glass, the AC voltage signals for the outputs of the analogue amplifiers and the variable supply voltage may also be generated via said microcontroller. It is thus possible to adapt the signal forms individually.

In one embodiment, the method further comprises the step of:
applying a variable supply voltage to the first analogue amplifier and the second analogue amplifier.

According to one embodiment, this variable supply voltage may also be used for the discharge, in that the discharge takes place via the power transistors of the upper voltage circuit by adapting the variable supply voltage. The adaptation of the variable supply voltage may be understood here to mean that the setpoint value of the variable supply voltage in the discharge phases has a lower value than the voltage value of the control voltage. For example, but not restrictively, the setpoint value of the variable supply voltage may be 1 volt less than the voltage value of the control voltage. The adaptation may be effected, for example, by a time shift of the two sinusoidal voltage profiles relative to one another.

By means of this embodiment, a discharge circuit can be dispensed with, since only existing components in combination with an advantageous actuation are used for the discharge.

Furthermore, a motor vehicle having a glass panel device is claimed and disclosed in the context of this application. The glass panel device is preferably the glass panel device already described above.

### BRIEF DESCRIPTION OF DRAWINGS

Exemplary embodiments of the invention are explained in more detail below with reference to the drawings. In partially greatly simplified representations, these show:

FIG. 1 schematic circuit diagram of the glass panel device according to the invention according to a first embodiment;

FIG. 2 schematic circuit diagram of the glass panel device according to the invention according to a second embodiment;

FIG. 3 schematic circuit diagram of a second voltage regulator for applying a variable supply voltage to the lower voltage circuit; and

FIG. 4 schematic circuit diagram of the glass panel device according to the invention according to a third embodiment.

### DETAILED DESCRIPTION

In the figures, components having the same effect are each represented by the same reference numerals.

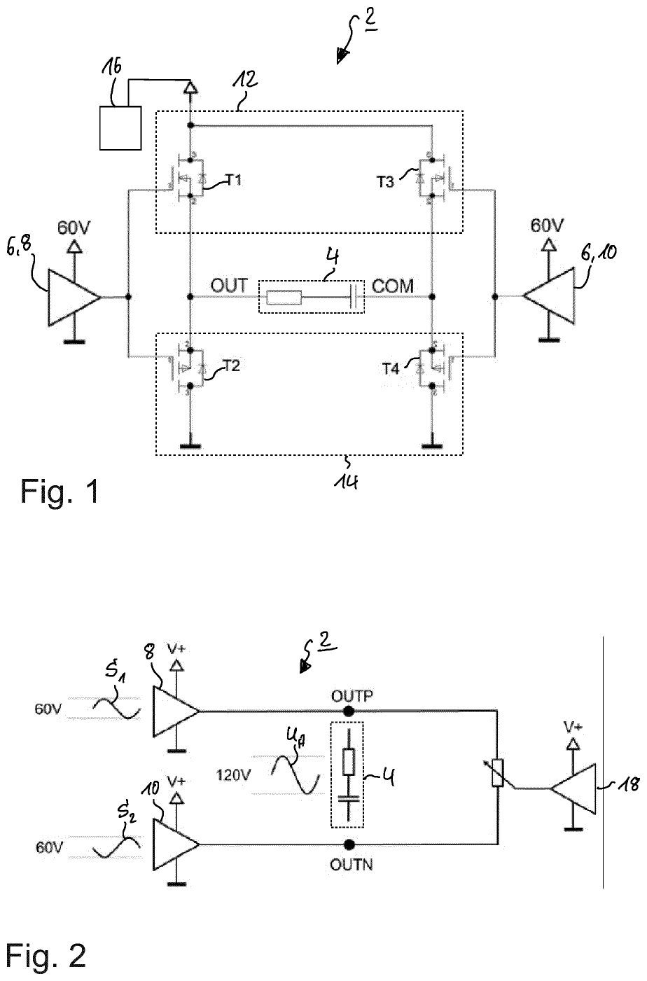

FIG. 1 schematically shows a circuit diagram of a glass panel device 2. The latter has a switchable glass panel 4, which is represented in the circuit diagram as an RC element only in the form of an equivalent circuit.

The glass panel device 2 further has a control unit 6, which has a first analogue amplifier 8 and a second analogue amplifier 10. For the sake of simplicity, only the two analogue amplifiers 8, 10 of the control unit 6 are represented in the figures. However, it goes without saying that this type of representation has no restrictive character with respect to the control unit 6. Rather, further components not described here may be part of the control unit 6.

The control unit 6 controls the switchable glass panel 4 with a control voltage U_{A} (cf. FIG. 2), which is composed of a first AC voltage signal (S₁), which is amplified by the first analogue amplifier 8, and of a second AC voltage signal S₂, which is amplified by the second analogue amplifier 10 (cf. FIG. 2). The first AC voltage signal S₁ is electrically phase-shifted by 180° with respect to the second AC voltage signal S₂.

Furthermore, the first analogue amplifier 8 has two first power transistors T1, T2 and the second analogue amplifier has two second power transistors T3, T4. The power transistors T1, T2, T3, T4 are embodied as MOSFETs in the exemplary embodiment. Each one power transistor T1, T3 of the two analogue amplifiers 8, 10 together form an upper voltage circuit 12, which is schematically represented by a dashed rectangle in the figures. The respective other power transistors T2, T4 of the two analogue amplifiers 8, 10 analogously form a lower voltage circuit 14.

The switchable glass panel 4 is connected between an output OUT of the first analogue amplifier 8 and an output COM of the second analogue amplifier 10.

As likewise shown in FIG. 1, the control unit 6 further has a first voltage regulator 16. The first voltage regulator 16 is configured and electrically connected to the upper voltage circuit 12 in order to apply a variable supply voltage thereto. In FIG. 1, the first voltage regulator 16 and its electrical connection to the upper voltage circuit 12 are represented only in a greatly simplified manner.

The above explained power loss minimization is effected by the glass panel device 2 described above, for example, in such a way that, in a discharge phase of the switchable glass panel 4, the variable supply voltage is applied to the output COM by one of the second power transistors T3 of the second analogue amplifier 10. However, the discharge during this application to the output COM additionally takes place via a (body) diode of the one first power transistor T1, embodied as a MOSFET, of the output OUT of the first analogue amplifier 6. The output OUT of the first analogue amplifier 8 is additionally discharged via the other first power transistor T2 against a ground potential.

The setpoint value of the variable supply voltage is at this point in time already below the voltage which is present at the output OUT of the first analogue amplifier 8. Therefore, nothing is fed in by the first voltage regulator 16. The discharge current of the output OUT of the first analogue amplifier 8 is thus conducted via the (body) diode of the one first power transistor T1 and via the one second power transistor T3 directly to the output COM of the second analogue amplifier 10. An additional discharge circuit and the actuation thereof can thereby be dispensed with.

The invention thus uses the present diodes of the power transistors T1 and T3 together with an easily adapted voltage profile of the variable supply voltage. In addition, the invention makes use of the circumstances of the asynchronous voltage regulator architecture, i.e. that these can only feed in current but cannot discharge.

A further prerequisite is that the output capacitance of the voltage regulator has to be significantly below the capacitance of the film, e.g. in the ratio 1:10. The variable supply voltage is adapted during operation in such a way that the setpoint value of this voltage during the discharge phases is approximately 1 V below the desired voltage profile.

As already described, bipolar transistors can also be used instead of the MOSFETs. However, diodes which function in accordance with the (body) diodes of the MOSFET variant described above then have to be implemented in parallel with the transistors T1 and T3.

FIG. 2 shows a circuit diagram of an alternative embodiment of the glass panel device 2 according to the invention. This alternative embodiment substantially corresponds to the embodiment in accordance with FIG. 1. For this reason, the circuit diagram in FIG. 2 is represented in a further simplified manner as compared with the circuit diagram in accordance with FIG. 1.

As a distinguishing feature from the embodiment in accordance with FIG. 1, the glass panel device 2 and especially the control unit 4 has a discharge unit 18, which is connected between the output OUT of the first analogue amplifier 8 and the output COM of the second analogue amplifier 10. The discharge unit 18 enables the previously described discharging of the switchable glass panel 4 in an alternative manner.

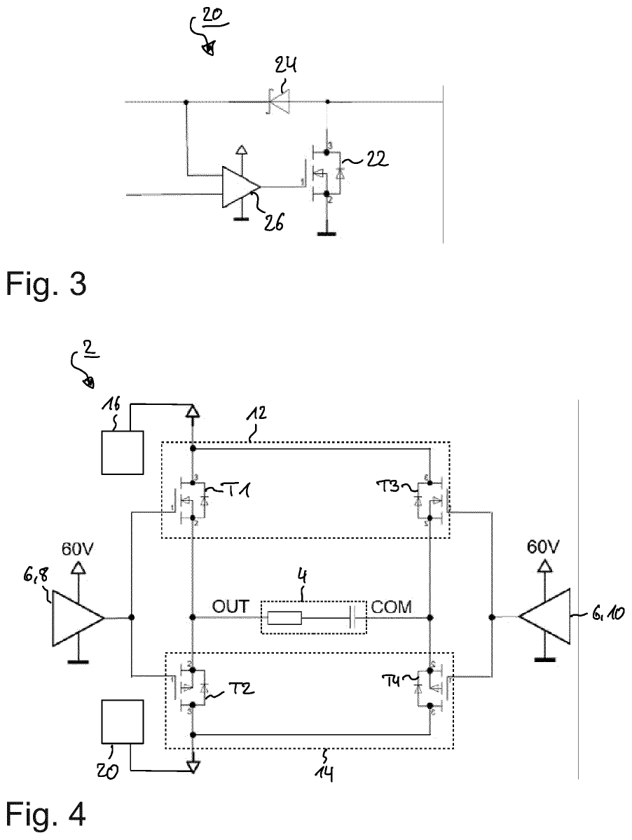

FIG. 3 shows a detailed structure of a second voltage regulator 20, which comprises a switch 22, a diode 24 and a comparator 26. The second voltage regulator 20 serves to apply a variable supply voltage to the lower voltage circuit 14 (cf. FIG. 4).

FIG. 4 shows a third embodiment of the glass panel device 2. The third embodiment of the glass panel device 2 substantially also corresponds to the first embodiment in accordance with FIG. 1. However, in this embodiment, the glass panel device 2 and especially the control unit 6 additionally comprises the above mentioned second voltage regulator 20, which is electrically connected to the lower voltage circuit 14 as shown in a greatly simplified manner. The general mode of operation has already been explained above, so that it is dispensed with at this point.

The invention is not restricted to the exemplary embodiments described above. Rather, other variants of the invention may also be derived therefrom by the person skilled in the art without departing from the subject matter of the invention. In particular, all individual features described in connection with the exemplary embodiments may also be combined with one another in another manner without departing from the subject matter of the invention.

### LIST REFERENCE NUMERALS

2 Glass panel device
4 Switchable glass panel
6 Control unit
8 First analogue amplifier
10 Second analogue amplifier
12 Upper voltage circuit
14 Lower voltage circuit
16 First voltage regulator
18 Discharge unit
20 Second voltage regulator
22 Switch
24 diode
26 comparator
S₁ first AC voltage signal
S₂ second AC voltage signal
U_{A} control voltage
OUT output of the first analogue amplifier
COM output of the second analogue amplifier
T1 first power transistor of the first analogue amplifier
T2 first power transistor of the first analogue amplifier
T3 second power transistor of the second analogue amplifier
T4 second power transistor of the second analogue amplifier

1. A glass panel device comprising:
a switchable glass panel; and
a control unit for controlling the switchable glass panel with a control voltage, wherein the control voltage comprises a first AC voltage signal and a second AC voltage signal, wherein the first AC voltage signal is phase-shifted by 180° with respect to the second AC voltage signal;
wherein the control unit has a first analogue amplifier for amplifying the first AC voltage signal with two first power transistors and a second analogue amplifier for amplifying the second AC voltage signal with two second power transistors, wherein each one power transistor of the two analogue amplifiers together form an upper voltage circuit and the respective other power transistors of the two analogue amplifiers together form a lower voltage circuit;
wherein the switchable glass panel is connected between an output of the first analogue amplifier and an output of the second analogue amplifier; and
wherein the control unit further has a first voltage regulator, which is configured to apply a variable supply voltage to the upper voltage circuit.

2. The glass panel device according to claim 1,
wherein the control unit has a discharge unit, which is connected between the output of the first analogue amplifier and the output of the second analogue amplifier.

3. The glass panel device according to claim 1,
wherein the control unit further has a second voltage regulator, which is configured to apply a variable supply voltage to the lower voltage circuit.

4. The glass panel device according to claim 3,
wherein the second voltage regulator comprises a switch, a diode, and a comparator.

5. The glass panel device according to claim 1,
wherein the first power transistors of the first analogue amplifier and the second power transistors of the second analogue amplifier are formed as at least one of: bipolar transistors and MOSFETs.

6. The glass panel device according to claim 1,
wherein the first AC voltage signal and the second AC voltage signal each have a voltage value in the range of 40V to 80V.

7. A method for controlling a switchable glass panel which is connected between an output of a first analogue amplifier and an output of a second analogue amplifier, wherein each one power transistor of the two analogue amplifiers together form an upper voltage circuit and each other power transistor of the two analogue amplifiers together form a lower voltage circuit, the method comprising the following steps:
applying to the switchable glass panel a control voltage which is provided by the two analogue amplifiers, wherein the control voltage comprises a first AC voltage signal and a second AC voltage signal phase-shifted by 180° with respect to the first AC voltage signal;
discharging the switchable glass panel, wherein the output of the first analogue amplifier is discharged via the output of the second analogue amplifier.

8. The method according to claim 7, further comprising the step of:
discharging the switchable glass panel, wherein the output of the first analogue amplifier is additionally discharged via a ground potential.

9. The method according to claim 7, further comprising the step of:
applying a variable supply voltage to the first analogue amplifier and the second analogue amplifier.

10. The method according to claim 9, further comprising the step of:
discharging the switchable glass panel via the power transistors of the upper voltage circuit by adapting the variable supply voltage in such a way that the setpoint value of the variable supply voltage is less than the voltage value of the control voltage.

11. A motor vehicle having a glass panel device comprising:
a switchable glass panel; and
a control unit for controlling the switchable glass panel with a control voltage, wherein the control voltage comprises a first AC voltage signal and a second AC voltage signal, wherein the first AC voltage signal is phase-shifted by 180° with respect to the second AC voltage signal;
wherein the control unit has a first analogue amplifier for amplifying the first AC voltage signal with two first power transistors and a second analogue amplifier for amplifying the second AC voltage signal with two second power transistors, wherein each one power transistor of the two analogue amplifiers together form an upper voltage circuit and the respective other power transistors of the two analogue amplifiers together form a lower voltage circuit;
wherein the switchable glass panel is connected between an output of the first analogue amplifier and an output of the second analogue amplifier; and
wherein the control unit further has a first voltage regulator, which is configured to apply a variable supply voltage to the upper voltage circuit.

12. The motor vehicle according to claim 11, wherein the control unit has a discharge unit, which is connected between the output of the first analogue amplifier and the output of the second analogue amplifier.

13. The motor vehicle according to claim 11, wherein the control unit further has a second voltage regulator, which is configured to apply a variable supply voltage to the lower voltage circuit.

14. The motor vehicle according to claim 13, wherein the second voltage regulator comprises a switch, a diode, and a comparator.

15. The motor vehicle according to claim 11, wherein the first power transistors of the first analogue amplifier and the second power transistors of the second analogue amplifier are formed as at least one of: bipolar transistors and MOSFETs.

16. The motor vehicle according to claim 11, wherein the first AC voltage signal and the second AC voltage signal each have a voltage value in the range of 40V to 80V.
